(19) United States
(12) Patent Application Publication
(10) Pub. No.: US 2002/0182315 A1
(43) Pub. Date: Dec. 5, 2002

(54) Surface treatment of non-plasma treated silicone hydrogel contact lenses

(76) Inventors: David J. Heiler, Avon, NY (US); Lisa C. Simpson, Rochester, NY (US); John Denick JR., Pittsford, NY (US); Suzanne F. Groemminger, Rochester, NY (US); Richard V. Smerbeck, Pittsford, NY (US)

Correspondence Address: Bausch & Lomb Incorporated, One Bausch & Lomb Place, Rochester, NY, 14604-2701, US

(21) Appl. No.: 10/140,600

(22) Filed: May 7, 2002

Related U.S. Application Data
(63) Continuation of application No. 09/703,696, filed on Nov. 1, 2000, now abandoned.

(51) Int. Cl. B05D 5/06; B05D 3/02; B05D 1/18

(52) U.S. Cl. 427/162; 427/387; 427/430.1

(57) ABSTRACT

The present invention provides an optically clear, hydrophilic coating upon the surface of a non-plasma treated hydrophobic hydrogel lens by heating the lens in an aqueous solution containing a surface-protective agent. Alternately, the non-plasma treated hydrophobic hydrogel lens may be subjected to ultrasonication while immersed in an aqueous solution containing a surface-protective agent.

### FIELD OF THE INVENTION

The present invention is directed toward surface treatment of non-plasma treated hydrophobic hydrogel contact lenses. More specifically, the present invention provides an optically clear, hydrophilic coating upon the surface of a non-plasma treated silicone hydrogel lens by subjecting the surface of the lens to an elevated temperature while the lens is immersed in a dilute aqueous solution comprising a silicate salt, silicic acid, colloidal silicon dioxide, or combinations thereof. The invention is also directed to a method of treating a non-plasma treated hydrophobic hydrogel contact lens such that the lens is packaged, sterilized and stored in a buffered, sterile solution containing a soluble silicate.

### BACKGROUND

Contact lenses made from silicone-containing materials have been investigated for a number of years. Such materials can generally be subdivided into two major classes, namely hydrogels and non-hydrogels. Non-hydrogels do not absorb appreciable amounts of water, whereas hydrogels can absorb and retain water in an equilibrium state. Regardless of their water content, both non-hydrogel and hydrogel hydrophobic contact lenses tend to have relatively non-wettable surfaces.

Those skilled in the art have long recognized the need for modifying the surface of such hydrophobic contact lenses so that they are compatible with the eye. It is known that increased hydrophilicity of the contact lens surface improves the wettability of the contact lenses. This in turn is associated with improved wear comfort of contact lenses. Additionally, the surface of the lens can affect the lens's susceptibility to deposition, particularly protein and lipid deposition from the tear fluid during lens wear. Accumulated deposition can cause eye discomfort or even inflammation. In the case of extended wear lenses, the surface is especially important since extended wear lens must be designed for high standards of comfort over an extended period of time, without requiring daily removal of the lens before sleep. Thus, the regimen for the use of extended wear lenses would not provide a daily period of time for the eye to recover from any discomfort or other possible adverse effects of lens wear.

The patent literature has disclosed various surface treatments for rendering the surface of hydrophobic contact lenses including those made with silicone materials more hydrophilic and more wettable, including changing the chemistry of the surface layer, coating the surface, and compounding the polymer with additives that subsequently diffuse to the surface.

Among chemical surface modification techniques are non-polymeric plasma treatments and corona treatments. This includes etching or the selective destruction of a surface layer. Surface modification techniques also include the introduction of functional groups onto a surface layer, for example the introduction of oxygenated functions (hydroxyls, carboxyls, etc.) at the surface of organic polymeric materials for the purpose of increasing hydrophilicity, thereby promoting increased wettability. Such techniques may employ flame treatments, corona treatments, or plasma treatments. Plasma treatments, also referred to as radio frequency gas discharge (RFGD), have been increasingly studied for the modification of surfaces. The plasma gas of RFGD contains vacuum UV radiation plus many reactive species, such as free radicals and energetic electrons and ions. Depending on the gas or vapor used in the plasma and the process conditions, the effects of non-polymeric or non-depositing plasma treatment include surface etching or ablation, oxidation, the formation of reactive groups, and combinations thereof.

Hydrophobic contact lenses including those prepared from silicone materials have been subjected to plasma surface treatment to improve their surface properties, e.g., surfaces have been rendered more hydrophilic, deposit resistant, scratch resistant, etc. Examples of previously disclosed plasma surface treatments include subjecting contact lens surfaces to a plasma comprising an inert gas or oxygen (see, for example, U.S. Pat. Nos. 4,055,378; 4,122,942; and 4,214,014).

Another type of chemical surface modification that has been disclosed in the patent literature involves the introduction of functional groups absent in the parent polymer by the grafting or immobilization of molecules, oligomers, or polymers onto a surface. Grafting or immobilization typically involves, first, the formation of a grafting site which may comprise the formation of a radical by means of chemical reactions, UV irradiation, ionizing radiation, plasma treatment, or the like. The next step is the reaction of the species to be grafted or immobilized with the active site. Surface grafting typically involves the propogation of the reaction to form an anchored chain, wherein competing solution and interfacial reactions occur. Surface crosslinking may occur.

Coating a lens usually involves adhesion of a surface layer onto the substrate being coated. The coated layer can be relatively thick and its physical characteristics can be significantly different than those of the substrate. For coatings that involve high-energy species, for example, evaporation, sputtering, plasma polymerization, the initial stages of the treatment can involve a surface treatment. A carbon coating can be formed by various hydrocarbon monomers (see for example U.S. Pat. No. 4,143,949) or combinations of oxidizing agents and hydrocarbons, e.g. water and ethanol. See, for example, WO 95/04609 and U.S. Pat. No. 4,632,844. Sequential plasma surface treatments are known, for example a first treatment with a plasma of an inert gas or oxygen, followed by a hydrocarbon plasma. See, for example, U.S. Pat. No. 5,326,584. U.S. Pat. No. 4,312,575 to Peyman et al. discloses a process for providing a barrier coating on a silicone or polyurethane lens by subjecting the lens to an electrical glow discharge (plasma) process conducted by first subjecting the lens to a hydrocarbon atmosphere followed by subjecting the lens to oxygen during flow discharge. U.S. Pat. No. 4,143,949 discloses depositing an ultrathin coating of a hydrophilic polymer by polymerizing a vapor of a hydrophilic monomer such as hydroxyalkylmethacrylate under electrodeless (corona) gas discharge conditions.

Non-plasma techniques for forming a coating have been disclosed. For example, U.S. Pat. No. 3,814,051 to Lewison discloses vacuum bonding a uniform hydrophilic quartz surface to a contact lens by vaporizing quartz, namely silicon dioxide, within a high vacuum chamber. The coating of contact lenses by dipping, swabbing, spraying or other mechanical means has been disclosed in U.S. Pat. No. 3,637,416 and 3,708,416 to Misch et al. The latter patents disclose a chemical process in which a coupling film-forming organic silicon compound, a vinyl trichlorosilane, is applied to a silicone surface, followed by a silica or silica gel deposit formed by contact with a silicon halide such as tetrachlorosilane or with a silicic ester, more particularly a tetraalkoxysilane. Solutions of such compounds can also be applied in a single step to a contact lens by dipping or the like. In U.S. Pat. No. 3,708,225, Misch et al. states that the capabilities of such solutions can be enhanced by incorporating a small amount of colloidal silica, preferably about 1 to 5 percent, whereby the solutions tend to thicken and become easier to apply, further facilitating the buildup of a silica or silica gel deposit.

U.S. Pat. No. 3,350,216 to McVannel et al. discloses rendering a rubber contact lens hydrophilic by dipping the lens into a solution of a titanate having the formula Ti(OR)₄ wherein R is an alkyl group containing 2 to 4 carbon atoms.

Although such surface treatments have been disclosed for modifying the surface properties of silicone contact lenses, the results have been problematic or of questionable commercial viability. For example, U.S. Pat. No. 5,080,924 to Kamel et al. states that although exposing the surface of an object to plasma discharge with oxygen is known to enhance the wettability or hydrophilicity of such surface, such treatment is only temporary.

Although the prior art has attempted to show that the surface treatment of contact lenses in the unhydrated state can be accomplished, there has been little or no discussion of the possible effect of subsequent processing or manufacturing steps on the surface treatment of the lens and no teaching or description of the surface properties of a fully processed hydrogel lens manufactured for actual wear. Similarly, there has been little or no published information regarding the performance of coatings for silicone hydrogel or extended wear lenses in the human eye.

Thus, it is desirable to provide a silicone hydrogel contact lens with an optically clear, hydrophilic surface coating that will not only exhibit improved wettability, but which will generally allow the use of a silicone hydrogel contact lens in the human eye, preferably for an extended period of time. In the case of a silicone hydrogel lens for extended wear, it would be highly desirable to provide a contact lens with a surface that is also highly permeable to oxygen and water. Such a surface treated lens would be comfortable to wear in actual use and would allow for the extended wear of the lens without irritation or other adverse effects to the cornea. It would be desirable if such a surface treated lens were a commercially viable product capable of economic manufacture.

### SUMMARY OF THE INVENTION

The present invention is directed to a non-plasma treated silicone hydrogel contact lens having a silicate-containing coating and a method of manufacturing the same, which coating is hydrophilic and resistant to protein and lipid deposition.

In one embodiment of the invention, the method comprises treating the non-plasma treated silicone hydrogel contact lens during autoclaving with a silicon- containing aqueous solution comprising a silicate salt, silicic acid, and/or colloidal silicon-dioxide. Treatment can be achieved during lens manufacture by submerging the lens in the surface-protective, silica-containing or silica-producing aqueous solution, preferably after lens hydration, followed by heating at an elevated temperature. (By the term solution is broadly meant true solutions as well as colloidal particles in solution, which colloids may be formed by supersaturated solutions.)

In a preferred embodiment, the non-plasma treated silicone hydrogel contact lens is packaged in a silicon-containing solution and the final package is autoclaved for sterilization purposes. A solution according to the present invention can, therefore, be used as a packaging solution for storage of a lens prior to customer use. Since such a solution has been shown safe for use in the eye, so that a lens packaged in the solution may be placed in the eye without rinsing.

### BRIEF DESCRIPTION OF DRAWINGS

FIG. 1 is a flow chart of a manufacturing process for making a lens having a lens coating according to the present invention.

### DETAILED DESCRIPTION OF THE INVENTION

As mentioned above, the present invention is directed toward the surface treatment of a non-plasma treated silicone hydrogel contact lens in order to allow the lens which otherwise could not be worn in the eye to be worn in the eye for an extended period of time, preferably for extended wear use.

As mentioned above, therefore, the present invention is directed to the manufacture of a hydrophilic surface coating on a non-plasma treated hydrophobic hydrogel lens which coating is durable after manufacture and which coating renders the lens wettable and allows the lens to be comfortably worn for extended periods of time. Also, it is desired that the lens be covered by a uniform coating having a thickness such that the relatively hydrophobic lens material is sufficiently distanced from eye tissue.

Commercially soluble silicates include silicate salts. A preferred silicate is the alkali metal silicate having the general formula M₂O.mSiO₂.nH₂O, where M is an alkali metal, preferably Na (sodium), and m and n is the number of moles of SiO₂ (silica) and H₂O, respectively, per mole of M₂O. The distribution of silicate species in aqueous sodium silicate solutions has long been of interest, and it is presently believed that silicate solutions contain a complex mixture of silicate anions in dynamic equilibrium. The composition of commercial alkali silicates is typically described by the weight ratio of SiO₂ to M₂O. These materials are usually manufactured as glasses that dissolve in water to form viscous, alkaline solutions. The ratio of SiO₂ to M₂O in commercial sodium silicate products typically varies from 0.5 to 4.0. A common form of soluble silicate, sometimes called waterglass, has a ratio of 3.2. Lower ratios of M₂O are preferred for use in this invention, for example, the sodium silicate coating a SiO₂ to M₂O ratio of 2.9 commercially available as Solution K from PQ Corp.

Silicate solutions, particularly sodium silicate solutions are preferred for use in the present invention. The pH of the silicate solution used to treat the silicone hydrogel lens is suitably around pH 7, preferably between about 6 to 8. Since sodium silicates are commercially available in alkaline form for increased solubility, a sodium silicate solution many be formed by neutralizing, by means of acidifying an alkaline solution of the silicate, for example, by changing the pH from about 10-11 to about 8. As a result of lowering the pH, the solution becomes potentially silica-containing according to the following equation (I):

Na₂SiO₃+2HCl→H₂SiO₃+2NaCl→(SiO₂)ₙ+nH₂O (I)

In accordance with the above equation, it is apparent that silicic acid can also be used to form silica. Thus, silicates and silicic acid are considered herein to be precursors of a silica-containing compound, silica or a polymer (SiO₂)ₙ thereof, or in other words, a colloidal silica that can protect the lens surface.

A colloidal silica or silicon dioxide material may be employed directly as a silica-containing material. Such materials are commercially available under various trade designations, including Cab-0-Sil® (Cabot Company), Santocel® (Monsanto), Ludox® (DuPont), and the like.

The invention is advantageous for application to non-plasma treated hydrophobic contact lenses including those prepared from silicone materials that have been packaged, awaiting sterilization.

The present invention is applicable to a wide variety of hydrophobic hydrogel materials. Hydrogels in general are a well known class of materials which comprise hydrated, cross-linked polymeric systems containing water in an equilibrium state. Silicone hydrogels generally have a water content greater than about 5 weight percent and more commonly between about 10 to about 80 weight percent. Such materials are usually prepared by polymerizing a mixture containing at least one silicone-containing monomer and at least one hydrophilic monomer. Typically, either the silicone-containing monomer or the hydrophilic monomer functions as a crosslinking agent (a crosslinker being defined as a monomer having multiple polymerizable functionalities) or a separate crosslinker may be employed. Applicable silicone-containing monomeric units for use in the formation of silicone hydrogels are well known in the art and numerous examples are provided in U.S. Pat. Nos. 4,136,250; 4,153,641; 4,740,533; 5,034,461; 5,070,215; 5,260,000; 5,310;779; and 5,358,995.

Another class of representative silicon-containing monomers includes silicone-containing vinyl carbonate or vinyl carbamate monomers such as: 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(tri-methylsiloxy) silyl]propyl vinyl carbamate; 3-[tris(trimethylsiloxy)silyl]propyl allyl carbamate; 3-[tris(trimethylsiloxy)silyl]propyl vinyl carbonate; t-butyldimethyl-siloxyethyl vinyl carbonate; trimethylsilylethyl vinyl carbonate; and trimethylsilylmethyl vinyl carbonate.

Another class of silicon-containing monomers includes polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference it its entirety.

Additionally, silicone hydrogels may contain other materials to increase oxygen permeability. An example of one such material includes fluorinated silicone prepolymers.

A preferred silicone hydrogel material comprises (in bulk formula, that is, in the monomer mixture that is copolymerized) 5 to 50 percent, preferably 10 to 25, by weight of one or more silicone macromonomers, 5 to 75 percent, preferably 30 to 60 percent, by weight of one or more polysiloxanylalkyl (meth)acrylic monomers, and 10 to 50 percent, preferably 20 to 40 percent, by weight of a hydrophilic monomer, as a percentage of the hydrogel polymer material. In general, the silicone macromonomer is a poly(organosiloxane) capped with an unsaturated group at one or more ends of the molecule, typically two or more ends for copolymerization. In addition to the end groups in the above structural formulas, U.S. Pat. No. 4,153,641 to Deichert et al. discloses additional unsaturated groups, including acryloxy or methacryloxy. Preferably, the silane macromonomer is a silicon-containing vinyl carbonate or vinyl carbamate or a polyurethane-polysiloxane having one or more hard-soft-hard blocks and end-capped with a hydrophilic monomer.

Suitable hydrophilic monomers for use in silicone hydrogels include, for example, unsaturated carboxylic acids, such as methacrylic and acrylic acids; acrylic substituted alcohols, such as 2-hydroxyethylmethacrylate and 2-hydroxyethylacrylate; vinyl lactams, such as N-vinyl pyrrolidone; and acrylamides, such as methacrylamide and N,N-dimethylacrylamide. Still further examples are the hydrophilic vinyl carbonate or vinyl carbamate monomers disclosed in U.S. Pat. Nos. 5,070,215, and the hydrophilic oxazolone monomers disclosed in U.S. Pat. No. 4,910,277. Other suitable hydrophilic monomers will be apparent to one skilled in the art.

Manufacture of the Lens.

Contact lenses according to the present invention can be manufactured, employing various conventional techniques, to yield a shaped article having the desired posterior and anterior lens surfaces. Spincasting methods are disclosed in U.S. Pat. Nos. 3,408,429 and 3,660,545; preferred static casting methods are disclosed in U.S. Pat. Nos. 4,113,224 and 4,197,266. Curing of the monomeric mixture is often followed by a machining operation in order to provide a contact lens having a desired final configuration. As an example, U.S. Pat. No. 4,555,732 discloses a process in which an excess of a monomeric mixture is cured by spincasting in a mold to form a shaped article having an anterior lens surface and a relatively large thickness. The posterior surface of the cured spincast article is subsequently lathe cut to provide a contact lens having the desired thickness and posterior lens surface. Further machining operations may follow the lathe cutting of the lens surface, for example, edge finishing operations.

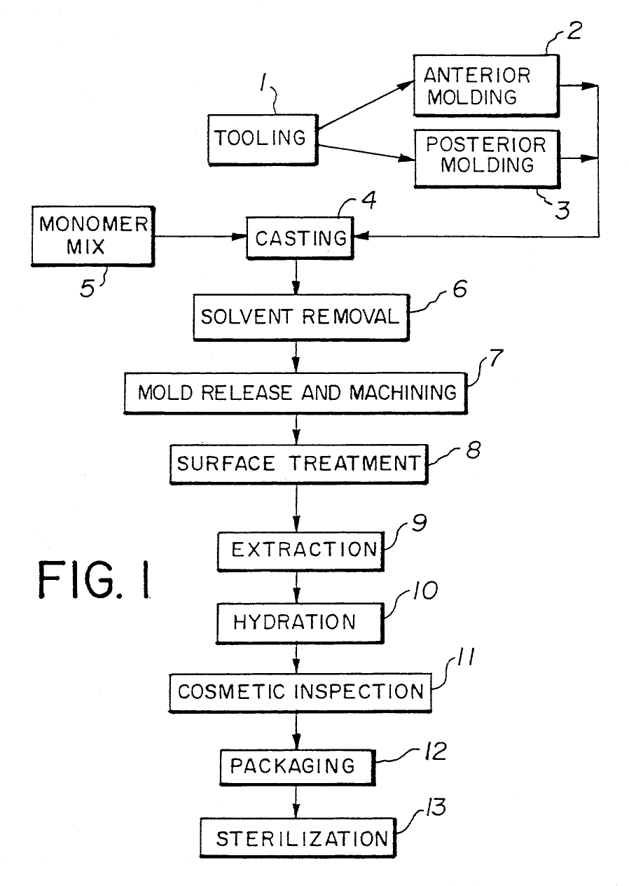

FIG. 1 illustrates a series of manufacturing process steps for static casting of lenses, wherein the first step is tooling (1) whereby, based on a given lens design, metal tools are fabricated by traditional machining and polishing operations. These metal tools are then used for injection or compression molding to produce a plurality of thermoplastic molds which in turn are used to cast the desired lenses from polymerizable compositions. Thus, a set of metal tools can yield a large number of thermoplastic molds. The thermoplastic molds may be disposed after forming a single lens. The metal molds fabricated during tooling (1) is then used for anterior molding (2) and posterior molding (3) in order to produce, respectively, an anterior mold section for forming the desired anterior lens surface and a posterior mold section for forming the desired posterior lens surface. Subsequently, during the operation of casting (4), a monomer mixture (5) is injected into the anterior mold section, and the posterior mold section is pressed down and clamped at a given pressure to form the desired lens shape. The clamped molds may be cured by exposure to UV light or other energy source for a certain period of time, preferably by conveying the molds through a curing chamber, after which the clamps are removed.

After producing a lens having the desired final shape, it is desirable to remove residual solvent from the lens before edge finishing operations. This is because, typically, an organic diluent is included in the initial monomeric mixture in order to minimize phase separation of polymerized products produced by polymerization of the monomeric mixture and to lower the glass transition temperature of the reacting polymeric mixture, which allows for a more efficient curing process and ultimately results in a more uniformly polymerized product. Sufficient uniformity of the initial monomeric mixture and the polymerized product are of particular concern for silicone hydrogels, primarily due to the inclusion of silicone-containing monomers which may tend to separate from the hydrophilic comonomer. Suitable organic diluents include, for example, monohydric alcohols, with C₆-C₁₀ straight-chained aliphatic monohydric alcohols such as n-hexanol and n-nonanol being especially preferred; diols such as ethylene glycol; polyols such as glycerin; ethers such as diethylene glycol monoethyl ether; ketones such as methyl ethyl ketone; esters such as methyl enanthate; and hydrocarbons such as toluene. Preferably, the organic diluent is sufficiently volatile to facilitate its removal from a cured article by evaporation at or near ambient pressure. Generally, the diluent is included at 5 to 60% by weight of the monomeric mixture, with 10 to 50% by weight being especially preferred.

The cured lens is, then, subjected to solvent removal (6) in the process of FIG. 1, which can be accomplished by evaporation at or near ambient pressure or under vacuum. An elevated temperature can be employed to shorten the time necessary to evaporate the diluent. The time, temperature and pressure conditions for the solvent removal step will vary depending on such factors as the volatility of the diluent and the specific monomeric components, as can be readily determined by one skilled in the art. According to a preferred embodiment, the temperature employed in the removal step is preferably at least 50° C., for example, 60 to 80° C. A series of heating cycles in a linear oven under inert gas or vacuum may be used to optimize the efficiency of solvent removal. The cured article after the solvent removal step should contain no more than 20% by weight of solvent, preferably no more than 5% by weight or less.

Following removal of the solvent, the lens is next subjected to mold release and optional machining operations (7) according to the process of FIG. 1. The machining step includes, for example, buffing or polishing the lens edge and/or surface. Generally, such machining processes may be performed before or after the lens is released from the mold part. Preferably, the lens is dry released from the mold by employing vacuum tweezers to lift the lens from the mold, after which the lens is transferred by means of mechanical tweezers to a second set of vacuum tweezers and placed against a rotating surface to smooth the surface or edges. The lens may then be turned over in order to machine the other side of the lens.

Subsequent to surface treatment (8) in FIG. 1, the lens is preferably subjected to extraction (9) to remove residual monomers and non-crosslinked polymers or oligomers in the lenses. Generally, in the manufacture of contact lenses, some of the monomer mix is not fully polymerized. The incompletely polymerized material from the polymerization process may affect optical clarity or may be harmful to the eye. Residual material may also include solvents not entirely removed by the previous solvent removal operation or even additives that may have migrated from the mold used to form the lens.

Conventional methods to extract such residual materials from the polymerized contact lens material include extraction with an alcohol solution for several hours (for extraction of hydrophobic residual material) followed by extraction with water (for extraction of hydrophilic residual material). Thus, some of the alcohol extraction solution remains in the polymeric network of the polymerized contact lens material, and should be extracted from the lens material before the lens may be worn safely and comfortably on the eye. Extraction of the alcohol from the lens can be achieved by placing the lens in water for a few minutes. Extraction should be as complete as possible, since incomplete extraction of residual material from lenses may contribute adversely to the useful life of the lens. Also, such residuals may impact lens performance and comfort by interfering with optical clarity or the desired uniform hydrophilicity of the lens surface. It is important that the selected the extraction solution in no way adversely affects the optical clarity of the lens. Optical clarity is subjectively understood to be the level of clarity observed when the lens is visually inspected.

Subsequent to extraction (9), the lens is subjected to hydration (10), in which the lens may be filly hydrated with water or buffered saline. The lens is ultimately fully hydrated and may expand by 10 to about 20 percent or more). The lens may be placed in a solution according to the present invention following hydration.

Following hydration (10), the lens should undergo cosmetic inspection (11), wherein trained inspectors inspect the contact lenses for clarity and the absence of defects such as holes, particles, bubbles, nicks, and tears. Inspection is preferably at 10× magnification. After the lens has passed cosmetic inspection (11), the lens is ready for packaging (12), whether in a vial, plastic blister package, or other container for maintaining the lens in a sterile condition for the consumer. Finally, the packaged lens is subjected to sterilization and simultaneous silica treatment (13), which may be accomplished in a conventional autoclave, preferably under an air pressurization sterilization cycle, sometime referred to as an air-steam mixture cycle, as will be appreciated by the skilled artisan. Preferably the autoclaving is at 100° C. to 200° C. for a period of 10 to 120 minutes. Following sterilization, the lens dimensions of the sterilized lenses may be checked prior to storage.

While the preferred method for coating the lens occurs simultaneously during sterilization, alternate methods may be utilized. One example is ultrasonication of the solution containing an immersed lens. Ultrasonication employs mechanical vibrations which create pressure waves in the solution. This action forms millions of microscopic bubbles (cavities) which expand during the negative pressure excursion, and implode violently during positive excursion. This phenomenon, referred to as cavitation, produces a powerful shearing action and causes the molecules in the liquid to become intensely agitated. The agitated silicon-containing molecules, for example, collide with the lens surface and become attached, forming a silicate-containing coating.

The treatment of the non-plasma treated silicone hydrogel contact lens with the silicon-containing solution during autoclaving forms the silicate coating under the rigorous conditions of sterilization. Thus, the silicon-containing agents in the solution contribute to the desired final coating and/or improve its final characteristics, including its hydrophilicity. The heating accelerates and promotes the precipitation of the silica onto the lens.

The lens may remain in the same solution subsequent to the autoclaving, which is particularly desirable if the lens is autoclaved in a sealed plastic blister pack. Thus, the present invention is also useful for packaging and storing a non-plasma treated contact lens, the method comprising packaging a contact lens immersed in an aqueous contact-lens solution, wherein the contact-lens solution comprises about 0.01 to 3.0, preferably about 0.02 to 2.0, more preferably about 0.03 to 1.0 percent by weight (dry weight) of soluble silicate, silicic acid, or collodial silica, or combinations thereof. Thus, according to one embodiment of the present invention, a contact lens may be immersed in the silicon-containing aqueous solution prior to delivery to the customer-wearer, during manufacture of the contact lens. Preferably the solution, both during autoclaving and in the final package, comprises greater than 90% by weight water, preferably about 93 to 99% by weight water. Consequently, a package for delivery to a customer may comprise a sealed container containing one or more unused contact lens immersed in an aqueous solution according to the present invention. Accordingly, one aspect or embodiment of the invention is directed to a system for the storage and delivery of a non-plasma treated contact lens comprising a sealed container, for example a glass vial or a conventional plastic blister package, containing one or more unused contact lens immersed in a solution comprising a silicon-containing solution, since some if not most of the silicon-containing material can remain in solution, preferably in the amount of 0.01 to 1.5 weight percent, more preferably 0.02 to 1.0 percent by weight (dry) in solution, even if some is deposited on the lens. Blister packs typically comprise a concave well adapted for containing the contact lens, which well is covered by a metal or plastic sheet adapted for peeling in order to open the hermetically sealed blister-pack. A popular type of contact lens is one that is disposable. Typically, most disposable contact lenses are packaged in a blister package.

In accordance with this aspect of the invention, therefore, a sterile ophthalmically safe aqueous storage solution comprising a soluble silicate, silicic acid, colloidal silica, or combinations thereof, may be used as a packaging solution for a contact lens. Such packaging solutions must be physiologically compatible. Specifically, the solution must be “ophthalmically safe” for use with a contact lens, meaning that the contact lens may be directly taken from its package for direct placement on the eye without first rinsing the lens with another solution, that is, a solution according to the present invention is safe for direct contact with the eye via a contact lens that has been immersed in, or wetted with, the solution. An ophthalmically safe solution has an osmolality and pH that is compatible with the eye and comprises materials, and amounts thereof, that are non-cytotoxic according to ISO standards and U.S. FDA (Food & Drug Administration) regulations. The solution should be sterile in that the absence of microbial contaminants in the product prior to release must be statistically demonstrated to the degree necessary for such products.

The packaging solution according to the present invention may contain, in addition to the silicon-containing component, an effective amount of at least one osmolality adjusting agent. Preferably, the aqueous solutions of the present invention for packaging contact lenses are adjusted with such agents to approximate the osmotic pressure of normal lachrymal fluids which is equivalent to a 0.9 percent solution of sodium chloride or 2.5 percent of glycerol solution, although opthalmologically safe variations are acceptable.

The solutions may be made substantially iso-osmotic with physiological saline used alone or in combination with other ingredients. Examples of suitable tonicity adjusting agents include, but are not limited to, sodium and potassium chloride, dextrose, glycerin, calcium and magnesium chloride. These agents are typically used individually in amounts ranging from about 0.01 to 2.5 % (w/v) and preferably, form about 0.2 to about 1.5% (w/v). Preferably, the tonicity agent will be employed in an amount to provide a final osmotic value of 200 to 450 mOsm/kg and more preferably between about 250 to about 350 mOsm/kg, and most preferably between about 280 to about 320 mOsm/Kg.

The pH of the solution in the package should be maintained within the range of 5.0 to 8.0, more preferably about 6.0 to 8.0, most preferably about 6.5 to 7.8. Suitable buffers may be added, such as boric acid, sodium borate, potassium citrate, citric acid, sodium bicarbonate, TRIS, and various mixed phosphate buffers (including combinations of Na₂HPO₄, NaH₂PO₄ and KH₂PO₄) and mixtures thereof. Borate buffers are preferred, particularly for enhancing the solubility of silicates. Generally, buffers will be used in amounts ranging from about 0.05 to 2.5 percent by weight, and preferably, from 0.1 to 1.5 percent. The packaging solutions of this invention preferably contain a borate buffer containing one or more of boric acid, sodium borate, potassium tetraborate, potassium metaborate or mixtures of the same.

The examples presented below are provided as a further guide to the practitioner of ordinary skill in the art and are not to be construed as limiting the invention in any way.

### EXAMPLE 1

This example discloses a representative silicone hydrogel lens material used in the following Examples. The formulation for the material is provided in Table 1 below.

TABLE 1

| Component | Parts by Weight |
|---|---|
| TRIS-VC | 55 |
| NVP | 30 |
| V₂D₂₅ | 15 |
| VINAL | 1 |
| n-nonanol | 15 |
| Darocur | 0.2 |
| tint agent | 0.05 |

The following materials are designated above:

| | |
|---|---|
| TRIS-VC | tris(trimethylsiloxy)silyipropyl vinyl carbamate |
| NVP | N-vinyl pyrrolidone |
| V₂D₂₅ | a silicone-containing vinyl carbonate as previously |
| | described in U.S. Pat. No. 5,534,604. |
| VINAL | N-vinyloxycarbonyl alanine |
| Darocur | Darocur-1173, a UV initiator |
| tint agent | 1,4-bis[4-(2-methacryloxyethyl)phenylamino] |
| | anthraquinone |

### EXAMPLE 2

This Example illustrates the preparation of a silicon-containing solution according to the present invention. The ingredients listed in Table 3 below were employed in preparing the solution.

TABLE 2

| Ingredient | mg/gm | | % w/w |
|---|---|---|---|
| Sodium Silicate, K grade (a 31.7% | 1.25 | | 0.0396** |
| solution from PQ Corporation) | | | |
| Boric Acid | 8.5 | | 0.850 |
| Sodium Borate | 0.9 | | 0.090 |
| Sodium Chloride | 4.5 | | 0.450 |
| Hydrochloric Acid, 1 N | 4.5 | | 0.450 |
| Sodium Hydroxide, 1 N | As needed* | | pH 7.1-7.4 |
| Purified Water q.s. to | 1.0 | gm | 100% |

*As needed to adjust pH.
**based on dry weight

Into an appropriate stainless steel vessel, equipped with agitation, purified water was formed a first solution as follows. Water was added in an amount equivalent to 80% of the total water volume, and agitation was initiated and maintained throughout the processing of the batch. In the order listed were added and dissolved the batch quantities of sodium chloride, boric acid, and sodium borate. The solution was mixed for a minimum of 10 minutes to ensure complete dissolution. In a separate container, a second solution was formed as follows. stock solution of sodium silicate was prepared at a concentration of 0.396% in purified water equivalent to 10% of the total water volume. The solution was filtered through a 0.45 μm filter. The filtered sodium silicate stock solution was then added to the first solution. The hydrochloric acid (1N) was slowly added to this solution, and the pH was adjusted, if necessary, with additional 1N Hydrochloric Acid or 1N Sodium Hydroxide solution. The remaining purified water was added to bring the batch to 100% of volume. The final product should have a pH at 25° C. of 7.0-7.4, an osmolality of 270-330 mOsm/Kg, and visual clarity (colorless to clear pale yellow).

### EXAMPLE 3

Four groups of lenses having three lenses each were prepared as in Example 1. The groups were treated as follows: Group 1 was lenses which were surface treated by simultaneously immersing the lenses in 0.125% silicate-containing solution and autoclaving; these lenses had no post treatment. Group 2 were lenses which were surface treated as in Group 1; after surface treatment, the lenses were rubbed and rinsed with a borate buffered saline (BBS) for 10 seconds on each side. Group 3 was lenses which were not surface treated and were not rubbed or rinsed with BBS. Group 4 was lenses which were not surface treated but were rubbed and rinsed as in Group 2. The surface treated lenses were immersed in the silicone-containing solution as prepared in Example 2. All lenses were analyzed by X-ray Photoelectron Spectroscopic (XPS) as follows:

The XPS data was acquired by a Physical Electronics [PHI] Model 5600 Spectrometer. To collect the data, the instrument's aluminum anode was operated at 300 watts, 15 kV, and 20 mA. The A1 Kα line was the excitation source monochromatized by a toroidal lens system. A 7 mm filament was utilized by the X-ray monochromator to focus the X-ray source which increases the need for charge dissipation through the use of a neutralizer. The base pressure of the instrument was 2.0×10−10 Torr while during operation it was 1.0×10−9 Torr. A hemispherical energy analyzer measures electron kinetic energy. The practical sampling depth of the instrument, with respect to carbon, at a sampling angle of 45°, is approximately 74 angströms. All elements were charge corrected to the peak of carbon binding energy of 285.0 eV.

Each of the plasma modified specimens was analyzed by XPS utilizing a low resolution survey spectra [0-1100 eV] to identify the elements present on the sample surface. The high resolution spectra were performed on those elements detected from the low resolution scans. The elemental composition was determined from the high resolution spectra. The atomic composition was calculated from the areas under the photoelectron peaks after sensitizing those areas with the instrumental transmission function and atomic cross sections for the orbital of interest. Since XPS does not detect the presence of hydrogen or helium, these elements will not be included in any calculation of atomic percentages. The atomic composition data has been outlined in Table 3.

TABLE 3

| | | | | | | % | % |
|---|---|---|---|---|---|---|---|
| Experiment 1 | | Oxygen | Nitrogen | Carbon | Silicon | O/C | Si/N |
| Lens | AVG | 38.4 | 4.6 | 41.9 | 15.2 | 0.9 | 3.3 |
| Grp #1 | STDEV | 1.0 | 0.3 | 1.2 | 0.6 | 0.0 | 0.3 |
| Lens | AVD | 34.4 | 4.8 | 45.8 | 15.0 | 0.8 | 3.1 |
| Grp #2 | STDEV | 2.2 | 0.3 | 2.8 | 0.4 | 0.1 | 0.1 |
| Lens | AVG | 18.8 | 6.8 | 64.5 | 9.7 | 0.3 | 1.4 |
| Grp #3 | STDEV | 0.1 | 0.3 | 0.3 | 0.2 | 0.0 | 0.1 |
| Lens | AVG | 18.8 | 7.1 | 64.9 | 9.2 | 0.3 | 1.3 |
| Grp #4 | STDEV | 0.3 | 0.2 | 0.4 | 0.4 | 0.0 | 0.1 |

The durability of the coating on the two surface treated groups #1 and #2 demonstrated little difference in the atomic composition after rubbing and rinsing. The increase in oxygen and silicone and the decrease in carbon and nitrogen indicate that coating has occurred. Uniformity may be indicated by low standard deviations.

### EXAMPLE 4

This Example illustrates the properties of a plasma-treated silicone lens treated, according to the present invention, with a silicate solution during autoclaving compared to such a lens autoclaved in a conventional saline solution.

In general, lens treated according to the present invention, compared to lens untreated with silicate, showed no adverse effects of the treatment. Lenses treated according to the present invention showed no cytotoxicity (Agar Overlay Assay) compared to the negative control. The oxygen permeability (dK) for the treated lens (0.125% Na silicate treated disc) was 89.4 versus 93.1 for an untreated disc, showing no significant change in oxygen permeability. The treated lens showed the same optical clarity as the untreated lens. Other measurements are shown in Table 4 below.

TABLE 4
Lens Dimensions

| | Sagittal | | | |
|---|---|---|---|---|
| Test | Depth | Diameter | C.T. | Power |
| Silicate | 3.640 | 13.944 | 0.084 | −3.88 |
| Treated Lens | mm +/− | mm +/− | mm +/− | D +/− |
| | 0.010 | 0.028 | 0.002 | 0.143 |
| Untreated | 3.636 | 14.031 | 0.080 | −3.85 |
| Lens | mm +/− | mm +/− | mm +/− | D +/− |
| | 0.016 | 0.079 | 0.010 | 0.098 |

Mechanical Properties

| Test | Modulus | Tensile St. | % Elong. | Tear |
|---|---|---|---|---|
| Silicate | 143 | 66 | 122% +/− 16 | 8.7 |
| Treated Lens | g/mm² +/− | g/mm² +/− | | g/mm +/− |
| | 18 | 12 | | 0.3 |
| Untreated | 144 | 68 | 111% +/− 15 | N/A |
| Lens | g/mm² +/− | g/mm² +/− | | |
| | 15 | 12 | | |

Many other modifications and variations of the present invention are possible in light of the teachings herein. It is therefore understood that, within the scope of the claims, the present invention can be practiced other than as herein specifically described.

1. A method for treating the surface of a non-plasma treated hydrophobic hydrogel contact lens comprising the following steps:
(a) immersing said lens in an aqueous composition comprising a surface-protective agent that comprises silica or a precursor thereof, and
(b) exposing said lens while in said aqueous composition to an elevated temperature.

2. The method of claim 1, wherein said hydrophobic hydrogel contact lens is a silicone-containing contact lens.

3. The method of claim 1, wherein said aqueous composition comprises greater than 90 percent by weight water and said surface-protective agent is selected from the group consisting of a silicate salt, silicic acid, colloidal silica, and combinations thereof.

4. The method of claim 3, wherein said aqueous composition is comprised of 0.125% sodium silicate.

5. The method of claim 1, wherein said aqueous composition is elevated to at least 100° C.

6. The method of claim 1, wherein step (b) comprises autoclaving in order to sterilize the lens.

7. The method of claim 1, wherein said lens is immersed in said aqueous composition while in a sealed package.

8. The method of claim 7, wherein said lens is autoclaved in a sealed package for delivery to the customer.

9. A method for treating the surface of a non-plasma treated silicone hydrogel contact lens comprising the following steps:
(a) immersing the lens surface in an aqueous solution comprising greater than 90 percent by weight water and 0.03 to 3.0 percent by weight of a surface-protective agent selected from the group consisting of a silicate salt, silicic acid, colloidal silica, and combinations thereof, and
(b) autoclaving said immersed lens for a period of 10 to 120 minutes at a temperature of 100 to 200° C.

10. A non-plasma treated silicone hydrogel contact lens including a hydrophilic surface, wherein said surface is obtained by immersing the lens in an aqueous solution comprising greater than 90 percent by weight water and 0.03 to 3.0 percent of a surface-protective agent selected from the group consisting of a silicate salt, silicic acid, colloidal silica, and combinations thereof while heating the solution.

11. A method for treating the surface of a non-plasma treated hydrophobic hydrogel contact lens comprising the following steps:
(a) immersing said lens in an aqueous composition comprising a surface-protective agent that comprises silica or a precursor thereof, and
(b) exposing said lens to an energy source such that said surface-protective agent attaches to said lens.

12. The method of claim 11, wherein said energy source is supplied by a device such as an ultrasonicator.
